(19) United States
(12) Patent Application Publication
(10) Pub. No.: US 2015/0038134 A1
(43) Pub. Date: Feb. 5, 2015

(54) METHOD OF OPTIMIZING DATA TRANSMISSION IN A WIRELESS NETWORK SYSTEM AND RELATED WIRELESS NETWORK SYSTEM

(71) Applicant: ACER INCORPORATED, New Taipei City (TW)

(72) Inventor: Tsung-Yo Cheng, New Taipei City (TW)

(73) Assignee: ACER INCORPORATED, New Taipei City (TW)

(21) Appl. No.: 14/246,141

(22) Filed: Apr. 6, 2014

Related U.S. Application Data
(60) Provisional application No. 61/862,093, filed on Aug. 5, 2013.

(51) Int. Cl. H04W 28/06; H04W 24/08; H04W 36/00

(52) U.S. Cl. CPC H04W 28/06; H04W 36/0022; H04W 24/08
USPC 455/426.1

(57) ABSTRACT

In a wireless network system, a fist channel is established between a user equipment and a 3GPP-based network and a second channel is established between the user equipment and an IP-based network. The user equipment is configured to measure its transmission status and calculate an MTU/fragmentation size for conducting a communication with a core network. The core network is configured to acquire an optimized MTU/fragmentation size according to the measured transmission status and the calculated path MTU/fragmentation size, and adjust its coding scheme according to the optimized MTU/fragmentation size. The user equipment is also configured to update its current MTU/fragmentation size according to the optimized MTU/fragmentation size.

### CROSS REFERENCE TO RELATED APPLICATIONS

This application claims the benefit of U.S. provisional application No. 61/862,093 filed on 2013 Aug. 5.

### BACKGROUND OF THE INVENTION

1. Field of the Invention

The present invention is related to a method of optimizing data transmission in a wireless network system and related wireless network system, and more particularly, to a method of optimizing data transmission in a wireless network system by dynamically adjusting a coding scheme of a core network and a MTU/fragmentation size of a user equipment according to the current transmission status of the user equipment and related wireless network system.

2. Description of the Prior Art

With rapid development in technology, a user may easily connect to a network using desktop computers, notebook computers, personal digital assistants (PDAs) or smart phones. Third generation (3G) and fourth generation (4G) wireless networks, as specified by the 3rd Generation Partnership Project (3GPP) include wireless access networks in which different application services, such as data services, voice over IP (VoIP) content or video content, can be delivered over various communication protocols, such as Internet protocol (IP) and Transmission Control Protocol (TCP). Both IP and TCP define size limits for packets transmitted over a network. The IP maximum transmission unit (MTU) defines the maximum size of IP packet that can be transmitted. The TCP maximum segment size (MSS) defines the maximum number of data bytes in a packet (excluding the TCP/IP headers). In computer networking, the size of an MTU/fragmentation may be fixed according to the adopted network access interfaces (such as Ethernet, WLAN, Token Ring or FDDI) or determined by relevant systems (such as point-to-point serial links) at connecting time.

As successive generations of operating standards proliferate, a wireless device is sometimes constructed to be operable in conformity with multiple communication standards associated with a single radio communication system-type or multiple communication system-types. For instance, a multi-mode device may provide a user with the capability of communicating with an Internet Protocol (IP)-based radio network and a 3GPP-based cellular network.

Operating procedures and protocols have promulgated, and others are undergoing promulgation, with respect to various aspects of interoperability between different communication systems. Interoperability between systems provides, for instance, procedures related to seamless transfer of communications between the respective communication systems. Unlicensed mobile access/generic access network (UMA/GAN) standard promulgations provide for seamless roaming operations and communication handovers between 3GPP-based cellular stations and IP-based networks. While the existing promulgation provides for communication of data frames, it fails to provide for efficient segmentation of data in such multi-mode device. Therefore, there is a need for a method of optimizing data transmission in a wireless network system capable of providing 3GPP-based and IP-based network abilities.

### SUMMARY OF THE INVENTION

The present invention provides a method of optimizing data transmission in a wireless network system. The method includes establishing a fist channel between a user equipment and a 3GPP-based network in the wireless network system, establishing a second channel between the multi-mode user equipment and an IP-based network in the wireless network system, a measuring a transmission status associated with the user equipment, calculating an MTU/fragmentation size for a communication between the user equipment and a core network, the core network acquiring an optimized MTU/fragmentation size according to the measured transmission status and the calculated path MTU/fragmentation size, and the core network adjusting a coding scheme according to the optimized MTU/fragmentation size.

The present invention also provides wireless network system including a 3GPP-based network, an IP-based network, a user equipment, and a core network. The user equipment includes a cellular access module configured to establish a fist channel between the user equipment and the 3GPP-based network; a generic access module configured to establish a second channel between the user equipment and the IP-based network; a status monitor configured to measure a transmission status associated with the user equipment; and an MTU/fragmentation calculator configured to calculate a path MTU/fragmentation size for a communication conducted by the user equipment. The core network is configured to acquire an optimized MTU/fragmentation size according to the measured transmission status and the calculated path MTU/fragmentation size; and optimize a coding scheme according to the optimized MTU/fragmentation size.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless network system according to an embodiment of the present invention.

FIG. 2 is a diagram illustrating a multi-layer structure according to an OSI network model for managing intercommunication within the wireless network system in FIG. 1.

FIG. 3 is a process diagram illustrating a method of optimizing data throughput rate in the wireless network system according to an embodiment of the present invention.

### DETAILED DESCRIPTION

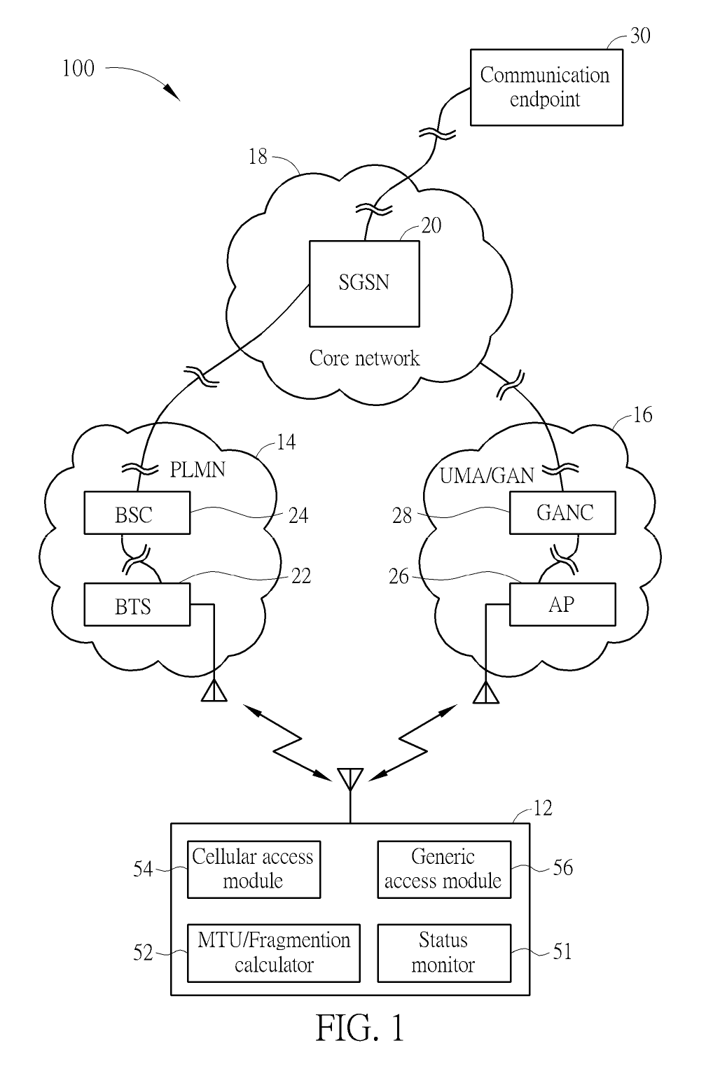

FIG. 1 is a diagram illustrating a wireless network system 100 according to an embodiment of the present invention. The wireless network system 100 includes one or multiple wireless devices (represented by a multi-mode user equipment 12), a public land mobile network (PLMN) 14 and a UMA/GAN 16, a core network 18 and a communication endpoint 30. The PLMN 14 may be representative of any 3GPP-based cellular network including, but not limited to, 2G, 2.5G, 3G or 4G network. The UMA/GAN 16 may be representative of any IP-based radio network including, but not limited to, a wireless local area network (WLAN) or a wireless fidelity (Wi-Fi) network.

The user equipment 12 includes a status monitor 51, an MTU/fragmentation calculator 52, an MTU/fragmentation calculator 52, a cellular access module 54 and a generic access module 56. Therefore, the user equipment 12 may register on the PLMN 14 using the cellular access module 54 and/or register on the UMA/GAN 16 using the generic access module 56, thereby providing dual-mode operation.

The PLMN networks 14 and the UMA/GAN 16 are coupled in communication connectivity by way of the core network 18. The core network 18 includes a serving general packet radio service support node (SGSN) 20 which is responsible for the delivery of data packets from and to the wireless devices within its geographical service area. In conformity with the 3GPP network structure, the network PLMN 14 is shown to include a base transceiver station (BTS) 22 and a base station controller (BSC) 24, while the UMA/GAN 16 is shown to include an access point (AP) 26 and a GAN controller (GANC) 28, also sometimes referred to as a UMA/GAN network controller (UNC). Noteworthily, the 2G-based BTS 22 and the BSC 24 may be substituted by their 3G-based equivalences of a NODE B and a radio network controller (RNC), respectively, or by their 4G-based equivalence of an e-NODE B. The communication endpoint 30 may be representative of any of various data destinations forming communication nodes used in performance of a communication service.

In the present invention, the user equipment 12 or the communication endpoint 30 may include multi-mode transportable electronic devices such as mobile telephones, personal digital assistants, handheld, tablet, nettop, or laptop computers, or other devices with similar telecommunication capabilities. In other cases, the user equipment 12 or the communication endpoint 30 may include multi-mode non-transportable devices with similar telecommunications capabilities, such as desktop computers, set-top boxes, or network appliances. The PLMN networks 14 and the UMA/GAN 16 are configured to provide local coverage (an area where the user equipment 12 or the communication endpoint 30 can work) for the wireless network system 100. However, the types of the user equipment 12, the communication endpoint 30, the PLMN networks 14 and the UMA/GAN 16 do not limit the scope of the present invention.

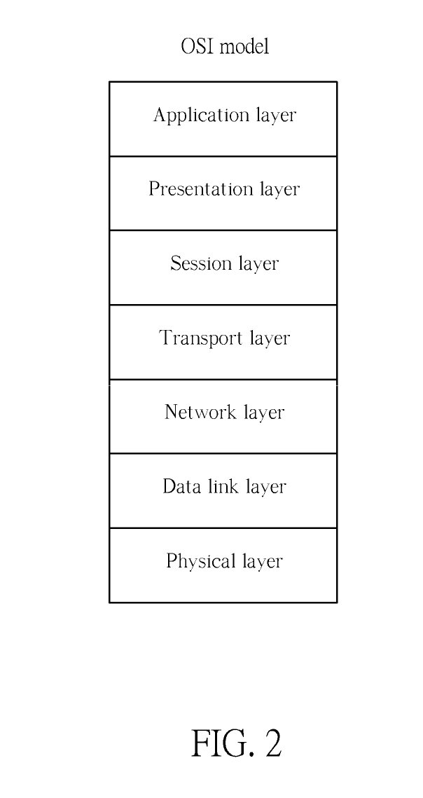

FIG. 2 is a diagram illustrating a multi-layer structure according to an OSI (Open Systems Interconnection) network model for managing intercommunication within the wireless network system 100. From bottom to top, Layer 1˜Layer 7 sequentially include physical layer, data link layer, network layer, transport layer, session layer, presentation layer, and application layer. The physical layer and the data link layer in the OSI model are configured to handle network hardware connection and may be implemented on various network access interfaces, such as Ethernet, Token-Ring or Fiber Distributed Data Interface (FDDI), etc. The network layer in the OSI model is configured to deliver messages between a transmitting network entity and a receiving network entity using various protocols, such as identifying addresses or selecting transmission path using IP, address Resolution Protocol (ARP), Reverse Address Resolution Protocol (RARP) or Internet Control Message Protocol (ICMP). The transport layer in the OSI model is configured to deliver messages between different network entities using TCP and User Datagram Protocol (UDP). The session layer, the presentation layer, and the application layer in the OSI model are configured to provide various application protocols, such as TELNET, File Transfer Protocol (FTP), Simple Mail Transfer Protocol (SMTP), Post Office Protocol 3 (POP3), Simple Network Management Protocol (SNMP), Network News Transport Protocol (NNTP), Domain Name System (DNS), Network Information Service (NIS), Network File System (NFS), and Hypertext Transfer Protocol (HTTP). The term “network entity” mentioned above may refer to any of the user equipment 12, the PLMN 14, the UMA/GAN 16, the core network 18 or the communication endpoint 30 in the wireless network system 100. However, the embodiment depicted in FIG. 2 does not limit the scope of the present invention.

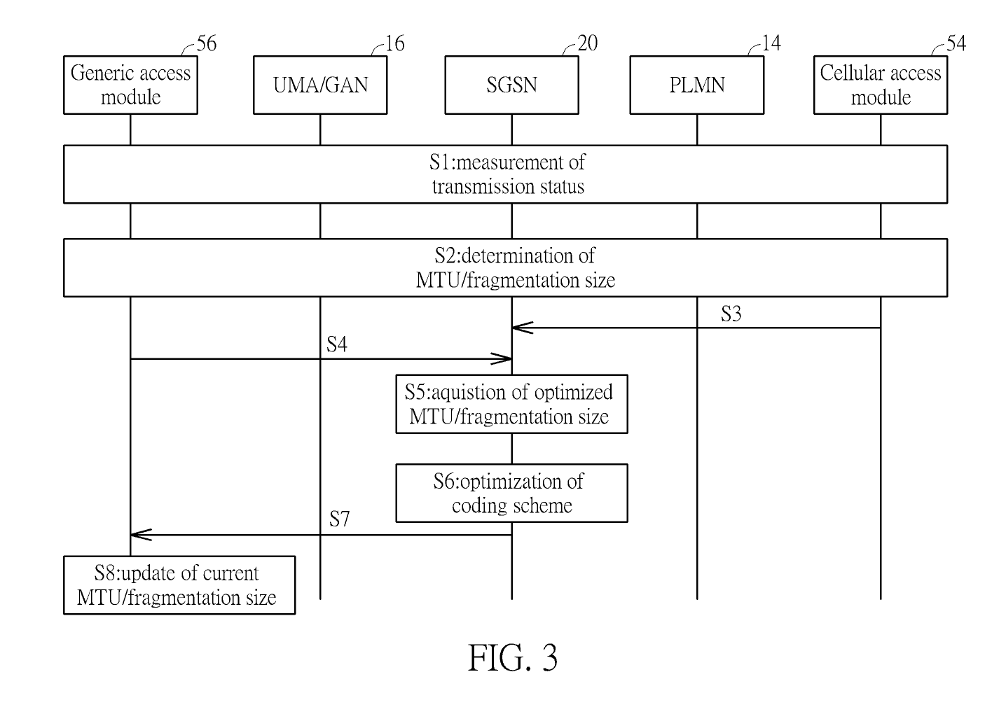

FIG. 3 is a process diagram illustrating a method of optimizing data throughput rate in the wireless network system 100 according to an embodiment of the present invention. It is assumed that the user equipment 12 has already registered on the PLMN 14 and the UMA/GAN 16 via the cellular access module 54 and the generic access module 56, respectively. The process diagram in FIG. 2 includes the following operations:

S1: the status monitor 51 measures a transmission status associated with the user equipment 12.

S2: the MTU/fragmentation calculator 52 determines a path MTU/fragmentation size for a communication conducting by the user equipment 12.

S3: the cellular access module 54 transmits the measured transmission status to the core network 18 via the PLMN 14.

S4: the generic access module 56 transmits the calculated path MTU to the core network 18 via the UMA/GAN16.

S5: the core network 18 acquires an optimized MTU/fragmentation size according to the transmission status and the path MTU/fragmentation size.

S6: the core network 18 optimizes it coding scheme according to the optimized MTU/fragmentation size.

S7: the core network 18 notifies the user equipment 12 of the optimized/fragmentation size.

S8: the user equipment 12 updates its current MTU/fragmentation size according to the optimized MTU/fragmentation size.

At S1, the status monitor 51 is configured to measure the transmission status associated with the user equipment 12. In one embodiment, the transmission status may be acquired by measuring a channel quality indicator (CQI) when corresponding layers of the user equipment 12 and the PLMN 14 are in communication. In another embodiment, the transmission status may be acquired by performing measurement reports defined in related 3GPP specifications (such as 3GPP TS 25.331). In yet another embodiment, the transmission status maybe acquired by measuring the packet lost rate or the packet error rate (PER) of a communication channel established the user equipment 12 and the SGSN 20. However, the method used to measure the transmission status in S1 does not limit the scope of the present invention.

At S2, the MTU/fragmentation calculator 52 may acquire the path MTU using any known path MTU discovery (PMTUD) technique. However, the method used to determine the path MTU in S2 does not limit the scope of the present invention.

At S3 and S4, the measured transmission status and the calculated path MTU/fragmentation size are transmitted to the core network 18 via the PLMN 14 and the UMA/GAN 16, respectively. In an embodiment, the measured transmission status and the calculated path MTU/fragmentation size may be transmitted to the core network 18 by means of signaling. In another embodiment, the measured transmission status and the calculated path MTU/fragmentation size may be transmitted to the core network 18 by means of RTCP RR/SR (real time control protocol receiver report/sender report) reporting. However, the methods used to transmit the measured transmission status and the calculated path MTU/fragmentation size in S3 and S4 do not limit the scope of the present invention.

At S5, the acquired optimized MTU/fragmentation size is associated with the transmission status and the path MTU/fragmentation size. In an embodiment, the core network 18 may initiate a standard XID negotiation to acquire an N201-U value based on the path MTU/ fragmentation size according to related 3GPP specifications. Then, the core network 18 may calculate the optimized MTU/fragmentation size according to the N201-U value and the transmission status. For example, the optimized MTU/fragmentation size may be larger than the N201-U value when the transmission status is better than a predetermined criteria; the optimized MTU/fragmentation size may be smaller than the N201-U value when the transmission status is worse than the predetermined criteria.

At S6, the core network 18 is configured to optimize it coding scheme according to the optimized MTU/fragmentation size. In an embodiment, the core network 18 may adjust the adaptive multi-rate (AMR) codec rate according to the optimized MTU/fragmentation size so that the audio data compression may be optimized according to the current transmission status. However, the type of coding scheme adopted by the core network 18 does not limit the scope of the present invention.

At S7, the core network 18 may notify the user equipment 12 of the optimized MTU/fragmentation size by means of signaling or RTCP RR/SR reporting.

At S8, the user equipment 12 may update its current MTU/fragmentation size according to the received optimized MTU/fragmentation size, thereby improving network resource utilization and overall data throughput of the wireless network system 100.

In conclusion, the present invention may provide a method of optimizing data transmission in a wireless network system. When a multi-mode user equipment capable of communicating with a 3GPP-based network and an IP-based network is in communication with a core network based on a multi-layer structure, the present invention can dynamically adjust the MTU/fragmentation size of the user equipment and the coding scheme of the core network according to the current transmission status of the user equipment, thereby improving network resource utilization and overall data throughput of the wireless network system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of optimizing data transmission in a wireless network system, comprising:
establishing a fist channel between a user equipment and a 3rd Generation Partnership Project (3GPP) -based network in the wireless network system;
establishing a second channel between the user equipment and an Internet protocol (IP)-based network in the wireless network system;
measuring a transmission status associated with the user equipment;
calculating a path maximum transmission unit (MTU)/fragmentation size for a communication between the multi-mode user equipment and a core network;
the core network acquiring an optimized MTU/fragmentation size according to the measured transmission status and the calculated path MTU/fragmentation size; and
the core network adjusting a coding scheme according to the optimized MTU/fragmentation size.

2. The method of claim 1, further comprising:
the user equipment updating a current MTU/fragmentation size according to the optimized MTU/fragmentation size.

3. The method of claim 1, wherein:
measuring the transmission status includes at least one of measuring a channel quality indicator (CQI), measuring a packet lost rate, measuring a packet error rate (PER), and performing a measurement report defined in a 3GPP specification.

4. The method of claim 1, further comprising:
transmitting the measured transmission status to the core network via the 3GPP-based network by means of signaling or a real time control protocol receiver report/sender report (RTCP RR/SR) reporting; and
transmitting the calculated path MTU/fragmentation size to the core network via the IP-based network by means of signaling or an RTCP RR/SR reporting.

5. The method of claim 1, wherein the core network acquiring the optimized MTU/fragmentation size includes:
calculating a reference value based on the path MTU/fragmentation size;
setting the optimized MTU/fragmentation size to a first value larger than the reference value when the transmission status is better than a predetermined criteria; and
setting the optimized MTU/fragmentation size to a second value smaller than the reference value when the transmission status is worse than the predetermined criteria.

6. The method of claim 1, wherein the core network optimizing the coding scheme includes adjusting an adaptive multi-rate codec rate according to the optimized MTU/fragmentation size.

7. The method of claim 1, further comprising:
the core network notifying the user equipment of the optimized MTU/fragmentation size by means of signaling or an RTCP RR/SR reporting.

8. A wireless network system, comprising:
a 3GPP-based network;
an IP-based network;
a user equipment comprising:
a cellular access module configured to establish a fist channel between the user equipment and the 3GPP-based network;
a generic access module configured to establish a second channel between the user equipment and the IP-based network;
a status monitor configured to measure a transmission status associated with the user equipment; and
an MTU/fragmentation calculator configured to calculate a path MTU/fragmentation size for a communication conducted by the user equipment; and
a core network configured to:
acquire an optimized MTU/fragmentation size according to the measured transmission status and the calculated path MTU/fragmentation size; and
optimize a coding scheme according to the optimized MTU/fragmentation size.

9. The wireless network system of claim 8, wherein the user equipment is configured to update a current MTU/fragmentation size according to the optimized MTU/fragmentation size.

10. The wireless network system of claim 8, wherein the status monitor is configured to measure the transmission status by at least one of measuring a channel quality indicator, measuring a packet lost rate, measuring a packet error rate, and performing a measurement report defined in a 3GPP specification.

11. The wireless network system of claim 8, wherein the user equipment is configured to:
transmit the measured transmission status to the core network via the 3GPP-based network by means of signaling or an RTCP RR/SR reporting; and
transmit the calculated path MTU/fragmentation size to the core network via the IP-based network by means of signaling or an RTCP RR/SR reporting.

12. The wireless network system of claim 8, wherein the core network is further configured to:
calculate a reference value based on the path MTU/fragmentation size;
set the optimized MTU/fragmentation size to a first value larger than the reference value when the transmission status is better than a predetermined criteria; and
set the optimized MTU/fragmentation size to a second value smaller than the reference value when the transmission status is worse than the predetermined criteria.

13. The wireless network system of claim 8, wherein the core network is configured to optimize the coding scheme by adjusting an adaptive multi-rate codec rate according to the optimized MTU/fragmentation size.

14. The wireless network system of claim 8, wherein the core network is further configured to notify the user equipment of the optimized MTU/fragmentation size by means of signaling or an RTCP RR/SR reporting.
